(19) United States
(12) Patent Application Publication
(10) Pub. No.: US 2010/0177062 A1
(43) Pub. Date: Jul. 15, 2010

(54) Light compensation method

(75) Inventors: Yun-Cheng Liu, Banciao City (TW); Chin-Kang Chang, Taoyuan City (TW); Yi-Ming Huang, Banchiao City (TW); Bo-Yi Wu, Xinzhuang City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Quanta Computer Inc.

(21) Appl. No.: 12/453,469

(22) Filed: May 12, 2009

(30) Foreign Application Priority Data
Jan. 13, 2009 (TW) 098101057

(51) Int. Cl. G06F 3/042

(52) U.S. Cl. 345/175

(57) ABSTRACT

The invention discloses a light compensation method applied in an optical touch system. The optical touch system includes a light emitting diode, an optical detector, and a reflector. The light emitting diode is used to illuminate toward the reflector. The reflector has a pattern. The optical detector is used to sense the illuminated reflector. The light compensation method of the invention provides a light compensation solution for overly brightness or light decay of the light emitting diode due to usage over a long period in the optical touch system.

### BACKGROUND OF THE INVENTION

1. Field of the Invention

This invention relates to a light compensation method, and more particularly, to the light compensation method, which can be applied in an optical touch system, for providing a light compensation approach to solve the problems that the light of a light source is overly bright or decays after being used over a long period of time.

2. Description of the Related Art

With the advances in technology, electronic products have more functions. People can input the necessary information into their electronic products with various kinds of input apparatuses (e.g., a keyboard, a mouse, etc.) by different kinds of input methods. To comply with people's requirements to input data quickly and conveniently, the input methods and the modules of electronic products nowadays are getting more diverse, and a touch panel is one of the major technologies. Since users can operate touch panels by inputting with their hands intuitively, as more electronic products adopt touch panels to be the operating interfaces, so that the requirement of touch panels increases.

The processes of how a touch panel works are described as follows. When a finger touches a sensor, an analog signal will be outputted. Afterwards, a controller converts the analog signal into a digital signal which can be recognized by a computer, and the digital signal is compiled by touch drivers in the computer. Finally, a video card outputs and shows the touched position on the monitor according to a monitor signal. Additionally, owing to different structures or sensing methods, touch panels can be approximately classified into resistive touch panels, capacitive touch panels, optical touch panels, etc. Since the quality and the processes of light emitting diodes have greatly improved in recent years, there are more manufacturers that invest in resources to develop related technologies of optical touch panels.

A known optical touch panel consists of infrared emitters and infrared receivers nearby, and the infrared rays parallel to X axis and Y axis form an array. The coordinate of the touched position can be determined when an opaque object obstructs the light.

Please refer to FIG. 1, FIG. 2A, and FIG. 2B. FIG. 1 is a schematic diagram illustrating an optical touch panel 4, wherein the obstructer 44 is disposed on the optical touch panel 4. FIG. 2A is a schematic diagram illustrating an image of the obstructer 44 captured by the infrared receiver 42 in FIG. 1, wherein the light emitted by the light emitting diode 40 is overly bright. FIG. 2B is a schematic diagram illustrating another image of the obstructer 44 captured by the infrared receiver 42 in FIG. 1, wherein the light emitted by the light emitting diode 40 is overly dark. As shown in FIG. 1, the known optical touch panel 4 includes a plurality of light emitting diodes 40 (e.g., two light emitting diodes shown in FIG. 1) and a plurality of infrared receivers 42. When the obstructer 44 is disposed on the optical touch panel 4 and the light emitted by the light emitting diodes 40 in the optical touch panel 4 are overly bright, the image of the obstructer 44 captured by the infrared receiver 42 will have some unrecognizable areas 440 owing to the halo phenomenon, as the areas 440 surrounded by the dotted lines shown in FIG. 2A. Additionally, if the light emitted by the light emitting diode 40 decays after being used for a long time, the image of the obstructer 44 captured by the infrared receiver 42 will similarly have some unrecognizable areas 442, as the areas 440 surrounded by the dotted lines shown in FIG. 2B.

Accordingly, the main scope of the invention is to provide a light compensation method, which can be applied in an optical touch system and drive the light emitting diodes with constant current, to keep the most proper brightness of the light emitting diode. Therefore, the halo phenomenon of the image of the obstructer captured by the infrared receiver caused by the overly bright light emitting diode can be improved. Additionally, the problem that the image can be recognized because of the decay of light will also be improved based on grayscale image technology.

### SUMMARY OF THE INVENTION

An objective of the invention is to provide a light compensation method, which can be applied in an optical touch system. The optical touch system has at least one light emitting diode, at least one optical detector, and a reflector. The at least one light emitting diode can be used to illuminate a light toward the reflector. The reflector has a pattern. The at least one optical detector can be used to sense the illuminated reflector. The light compensation method includes the steps of:

(a) adjusting the brightness of the light dynamically;

(b) capturing M images related to the pattern dynamically, wherein M is an integer larger than 1;

(c) recording M modulation transformation function values related to the M images respectively;

(d) selecting N images of which the modulation transformation function values are larger than a first predetermined reference value from the M images, wherein N is an integer larger than 1;

(e) selecting an image of which the gray value is smaller then a second predetermined reference value and the modulation transformation function value is the biggest from the N images; and

(f) illuminating the light having a brightness corresponding to the image toward the reflector.

Additionally, another objective of the invention is to provide another light compensation method, which can also be applied in an optical touch system. The optical touch system has at least one light emitting diode, at least one optical detector, and a reflector. The at least one light emitting diode can be used to illuminate a light toward the reflector. The reflector has a pattern. The at least one optical detector can be used to capturing an image related to the illuminated pattern. The light compensation method includes the steps of:

(a) adjusting the brightness of the light;

(b) calculating a modulation transformation function value of the pattern;

(c) determining whether the modulation transformation function value is larger than a first predetermined reference value, if YES, executing step (d); and

(d) determining whether the gray value of the pattern is smaller than a second predetermined reference value, if YES, illuminating the adjusted light toward the reflector, if NO, executing step (a) again.

Compared with the prior arts, the light compensation method of the invention drive the light emitting diodes with constant current, to keep the most proper brightness of the light emitting diode. Therefore, the halo phenomenon of the image of the obstructer captured by the infrared receiver caused by the overly bright light emitting diode can be improved. Additionally, the problem that the image can be recognized because of the decay of light will also be improved based on grayscale image technology.

The advantage and spirit of the invention may be understood by the following recitations together with the appended drawings.

### BRIEF DESCRIPTION OF THE APPENDED DRAWINGS

FIG. 1 is a schematic diagram illustrating an optical touch panel.

FIG. 2A is a schematic diagram illustrating an image of the obstructer which is captured by the infrared receiver in FIG. 1.

FIG. 2B is a schematic diagram illustrating another image of the obstructer which is captured by the infrared receiver in FIG. 1.

FIG. 3 is a schematic diagram illustrating an optical touch system according to an embodiment of the invention.

FIG. 4 is a flow chart diagram showing the light compensation method according to an embodiment of the invention.

FIG. 5 is a schematic diagram illustrating a pulse width modulation controller operated with constant current.

FIG. 6 is a schematic diagram illustrating a brightness distribution of an image of the reflector detected by the optical detector in FIG. 3.

FIG. 7 is a schematic diagram illustrating the image of the reflector which is detected by the optical detector in FIG. 3.

FIG. 8 is a flow chart diagram showing the light compensation method according to another embodiment of the invention.

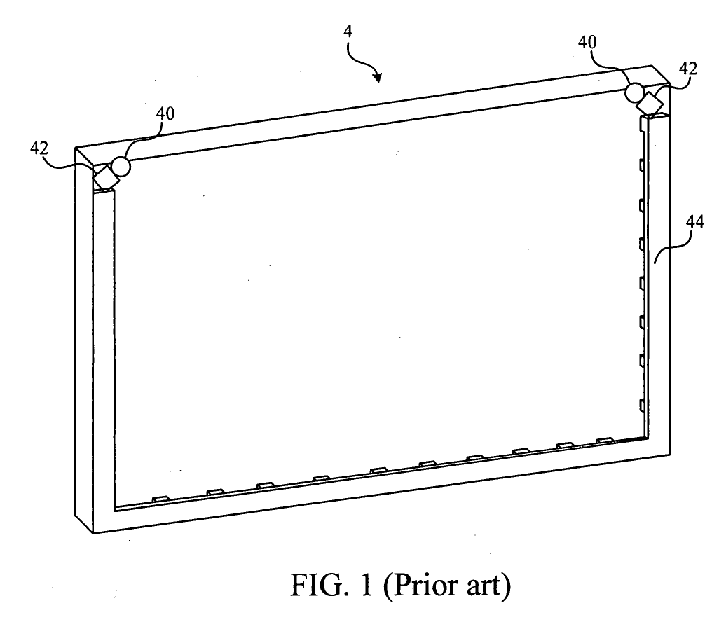

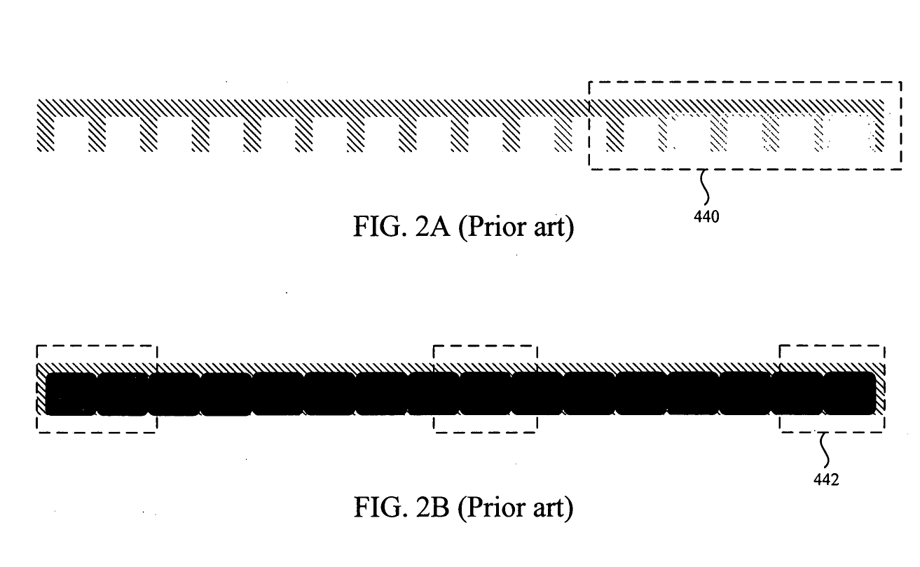

### DETAILED DESCRIPTION OF THE INVENTION

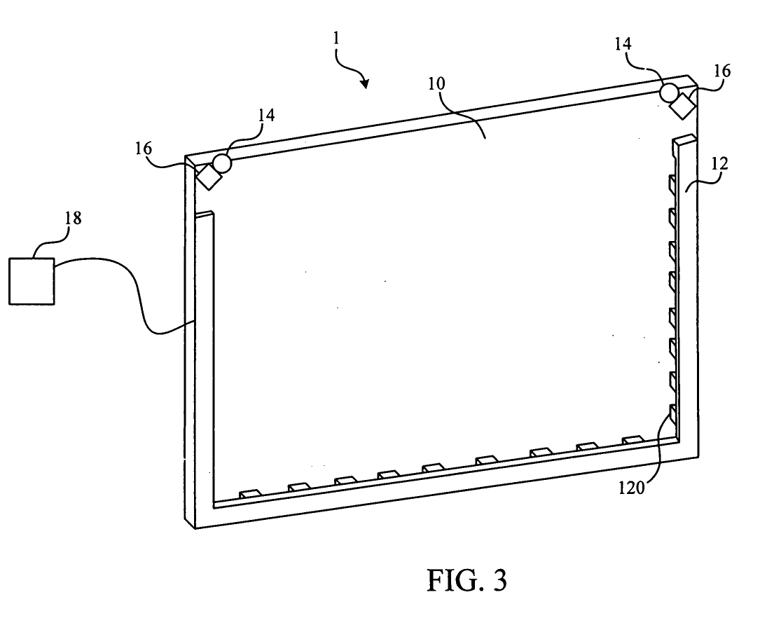

Please refer to FIG. 3. FIG. 3 is a schematic diagram illustrating an optical touch system 1 according to an embodiment of the invention. The invention provides a light compensation method which can be applied in the optical touch system 1. The optical touch system 1 includes light emitting diodes 14, optical detectors 16, a reflector 12, a panel 10, and a pulse width modulation controller 18. In the embodiment, the numbers of the light emitting diodes 14 and the optical detectors 16 are, but not limited to, two.

The light emitting diodes 14 can be used to illuminate a light toward the reflector 12, wherein the reflector 12 is a frame which is disposed along the edge of the panel 10. The reflector 12 has a plurality of obstructing portions 120, and the obstructing portions 120 form the pattern. The optical detector 16 can be used to sense the illuminated reflector 12. The pulse width modulation controller 18 is electrically connected to the light emitting diode 14 for adjusting the brightness of the light.

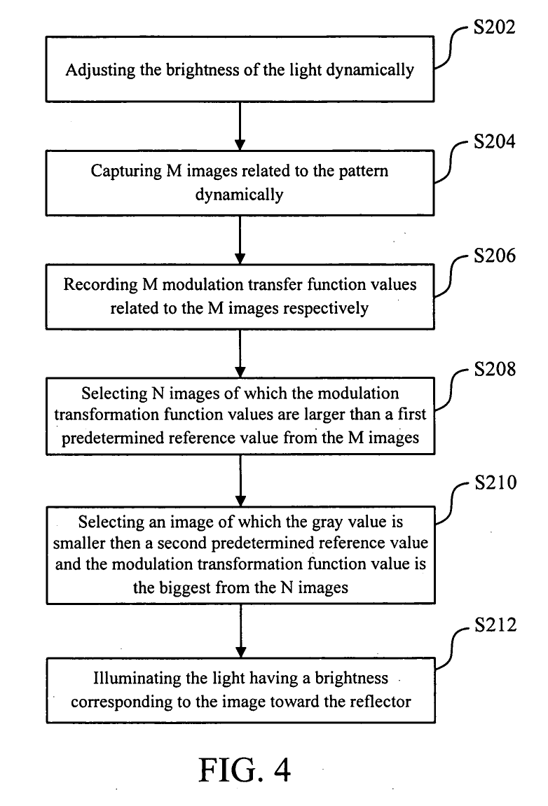

Please refer to FIG. 4. FIG. 4 is a flow chart diagram showing the light compensation method according to an embodiment of the invention. The light compensation method includes the following steps.

Firstly, step S202 is performed to adjust the brightness of the light dynamically.

Afterwards, step S204 is performed to capture M images related to the pattern dynamically, wherein M is an integer larger than 1.

Afterwards, step S206 is performed to record M modulation transfer function values related to the M images respectively.

Afterwards, step S208 is performed to select N images of which the modulation transfer function values are larger than a first predetermined reference value from the M images, wherein N is an integer larger than 1.

Afterwards, step S210 is performed to select an image of which the gray value is smaller then a second predetermined reference value and the modulation transformation function value is the biggest from the N images.

Finally, step S212 is performed to illuminate the light having a brightness corresponding to the image toward the reflector.

In practical application, the optical touch system 1 drives the light emitting diode 14 by the pulse width modulation controller 18 with an adjusted constant current. The brightness of the light emitting diode 14 will be kept at the most proper brightness to illuminate a light toward the reflector 12. Wherein, the reflector 12 has a plurality of obstructing portions 120, and the obstructing portions 120 form the pattern. The optical detector 16 senses the image of the illuminated reflector 12.

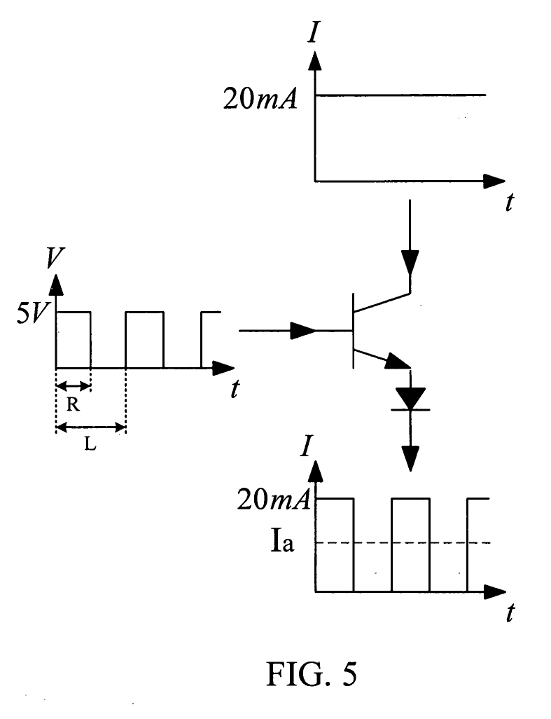

Please refer to FIG. 5. FIG. 5 is a schematic diagram illustrating a pulse width modulation controller operated with constant current. The adjustment processes are described below.

Firstly, a particular touch object is placed on the optical touch system 1 according to the light compensation method of the invention.

Then, the duty ratio d of the pulse width modulation controller 18 is adjusted form the smallest to the largest. As shown in FIG. 5, the duty ratio d=R/L, wherein R is the potential turn-on time per unit cycle, and L is of the unit cycle potential. The average current Iₐ=d*20 mA, wherein the light emitting diode 14 is driven with the average current Iₐ. The value of Iₐ is changed while the value of d is adjusted form the smallest to the largest, such that the brightness of the light emitting diode 14 is changed from the darkest to the brightest.

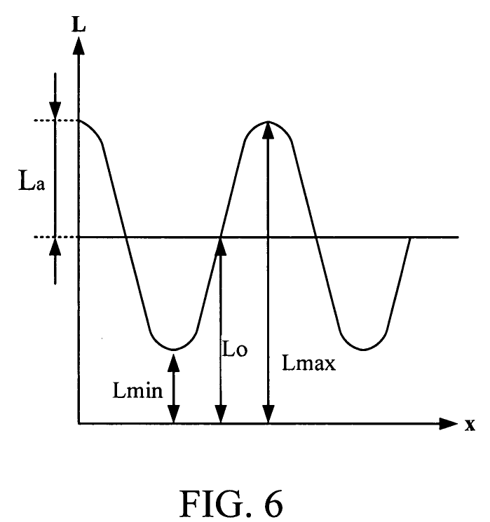

As shown in FIG. 6, FIG. 6 is a schematic diagram illustrating a brightness distribution of an image of the reflector 12 detected by the optical detectors 16 in FIG. 3, wherein the reflector 12 is illuminated by the light emitting diode 14. In FIG. 6, the vertical axis represents brightness L, and the horizontal axis represents the x coordinates along the length direction of the reflector 12.

$$The modulation transformation function value = \frac{( {L}_{max} - {L}_{min} )}{( {L}_{max} + {L}_{min} )} = \frac{{L}_{a}}{{L}_{o}} .$$

Wherein, Lₘₐₓ, Lₘᵢₙ, Lₒ, and Lₐ are the maximum value of the brightness, the minimum value of the brightness, the average value of the brightness, and the value that Lₘₐₓ subtracts from Lₐ. In practical application, the modulation transfer function values is controlled in a preferred range, such as 0.8˜1. In the preferred range, the quality of the image detected by the optical detector 16 when the light emitting diode 14 is overly bright can be improved. But it might have a problem that the light emitting diode 14 is overly dark.

Therefore, the gray value of the image can be adjusted subsequently according to the light compensation method of the invention. Since the contrast of the image detected by the optical detector 16 is too low when the light emitting diode 14 is too dark, the image with the foregoing modulation transfer function values will be selectively deleted to prevent the foregoing problem.

Finally, the most proper duty ratio d can simultaneously pass the requirements of the modulation transfer function and the gray value according to the light compensation method of the invention.

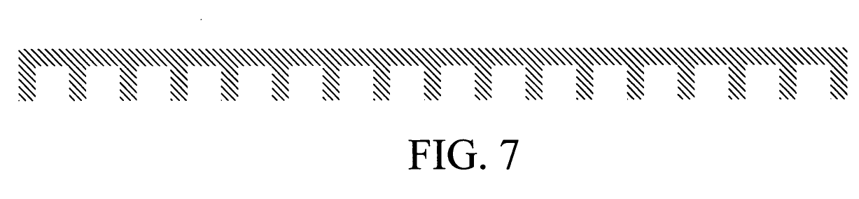

Please refer to FIG. 7. FIG. 7 is a schematic diagram illustrating the image of the reflector 12 detected by the optical detectors 16 in FIG. 3. After the light compensation method of the invention have been applied, the image of the illuminated reflector 12 detected by the optical detector 16 will have a clear contour, as shown in FIG. 7.

Compared with the prior arts, the light compensation method of the invention drive the light emitting diodes with constant current, so as to keep the most proper brightness of the light emitting diode. Therefore, the halo phenomenon of the image of the obstructer captured by the infrared receiver caused by the overly bright light emitting diode can be improved. Additionally, the problem that the image can be recognized because of the decay of light will also be improved based on grayscale image technology.

Additionally, according to another embodiment of the invention, the invention provides another light compensation method. The light compensation method can also be applied in the optical touch system 1. The optical touch system 1 includes the light emitting diodes 14, the optical detectors 16, the reflector 12, the panel 10, and the Pulse width modulation controller 18.

The light emitting diodes 14 can be used to illuminate a light toward the reflector 12, and the reflector 12 is a frame which is disposed along the edge of the panel. The reflector 12 has the plurality of obstructing portions 120, and the obstructing portions 120 form the pattern. The optical detector 16 can be used to capturing an image related to the illuminated pattern. The pulse width modulation controller 18 is electrically connected to the light emitting diode 14 for adjusting the brightness of the light.

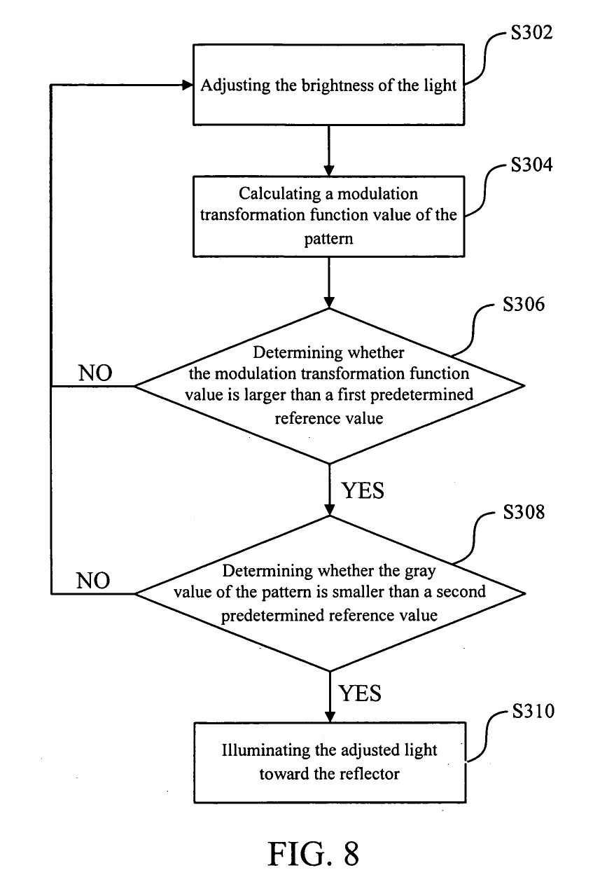

Please refer to FIG. 8. FIG. 8 is a flow chart diagram illustrating the light compensation method according to another embodiment of the invention. The light compensation method includes the following steps.

Firstly, step S302 is performed to adjust the brightness of the light.

Afterwards, step S304 is performed to calculate a modulation transformation function value of the pattern.

Afterwards, step S306 is performed to determine whether the modulation transformation function value is larger than a first predetermined reference value. If the result is positive, step 308 will be executed; if the result is negative, step 302 will be executed again.

Afterwards, step S308 is performed to determine whether the gray value of the pattern is smaller than a second predetermined reference value. If the result is positive, step 310 will be executed to illuminate the adjusted-light toward the reflector 12; if the result is negative, step (a) will be executed again.

Compared with the prior arts, the light compensation method of the invention drive the light emitting diodes with constant current, to keep the most proper brightness of the light emitting diode. Therefore, the halo phenomenon of the image of the obstructer captured by the infrared receiver caused by the overly bright light emitting diode can be improved. Additionally, the problem that the image can be recognized because of the decay of light will also be improved based on grayscale image technology.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as being limited only by the metes and bounds of the appended claims.

What is claimed is:

1. A light compensation method being applied in an optical touch system, the optical touch system having at least one light emitting diode, at least one optical detector, and a reflector, the at least one light emitting diode being used to emit a light toward the reflector, the reflector having a pattern, the at least one optical detector being used to sense the illuminated reflector, the light compensation method comprising the steps of:
(a) adjusting the brightness of the light dynamically;
(b) capturing M images related to the pattern dynamically, wherein M is an integer larger than 1;
(c) recording M modulation transfer function values related to the M images respectively;
(d) selecting N images of which the modulation transformation function values are larger than a first predetermined reference value from the M images, wherein N is an integer larger than 1;
(e) selecting an image of which the gray value is smaller then a second predetermined reference value and the modulation transformation function value is the biggest from the N images; and
(f) illuminating the light having a brightness corresponding to the image toward the reflector.

2. The light compensation method of claim 1, wherein the optical touch system further comprises a panel, and the reflector is a frame which is disposed along the edge of the panel.

3. The light compensation method of claim 1, wherein the reflector has a plurality of obstructing portions, and the obstructing portions form the pattern.

4. The light compensation method of claim 1, wherein the optical touch system further comprises a pulse width modulation controller, electrically connected to the light emitting diode, for adjusting the brightness of the light.

5. A light compensation method being applied in an optical touch system, the optical touch system having at least one light emitting diode, at least one optical detector, and a reflector, the at least one light emitting diode being used to illuminate a light toward the reflector, the reflector having a pattern, the at least one optical detector being used to capturing an image related to the illuminated pattern, the light compensation method comprising the steps of:
(a) adjusting the brightness of the light;
(b) calculating a modulation transformation function value of the pattern;
(c) determining whether the modulation transformation function value is larger than a first predetermined reference value, if YES, executing step (d); and
(d) determining whether the gray value of the pattern is smaller than a second predetermined reference value, if YES, illuminating the adjusted light toward the reflector, if NO, executing step (a) again.

6. The light compensation method of claim 5, wherein the optical touch system further comprises a panel, and the reflector is a frame which is disposed along the edge of the panel.

7. The light compensation method of claim 5, wherein the reflector has a plurality of obstructing portions, and the obstructing portions form the pattern.

8. The light compensation method of claim 1, wherein the optical touch system further comprises a pulse width modulation controller, electrically connected to the light emitting diode, for adjusting the brightness of the light.
